(19) United States
(12) Patent Application Publication
(10) Pub. No.: US 2019/0242330 A1
(43) Pub. Date: Aug. 8, 2019

(54) FUEL DETONATION COMBUSTION PULSE DEVICE

(71) Applicant: Khaled Abdullah Alhussan, Riyadh (SA)

(72) Inventor: Khaled Abdullah Alhussan, Riyadh (SA)

(21) Appl. No.: 16/269,513

(22) Filed: Feb. 6, 2019

Related U.S. Application Data
(60) Provisional application No. 62/626,845, filed on Feb. 6, 2018.

(51) Int. Cl. F02K 7/075; F02C 5/02

(52) U.S. Cl. CPC F02K 7/075; F02C 5/02

(57) ABSTRACT

A fuel detonation combustion pulse device includes a semispherical combustion chamber, a fuel supply system, a spark plug, a detonation accelerator, a hemispherical combustion chamber having a conic duct for transition to the detonation tube; a spark plug is mounted at the end wall of the sphere of the combustion chamber along its longitudinal axis, a fuel supply system is formed as a co-axial injector for fuel; an annular oxidant supply nozzle located perpendicular to the longitudinal axis of the device, and a detonation accelerator is shaped as a profiled stepped obstacle and is mounted in the combustion chamber conic duct for transition to the detonation tube being axial with it.

### BACKGROUND

### 1. Field of the Invention

The invention relates to propulsion engineering and can be used to create the vehicle thrust and to obtain the engine torque in power plants of various purpose.

Although great strides have been made in the art many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is cross-sectional side view of a fuel detonation combustion pulse device in accordance with a preferred embodiment of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

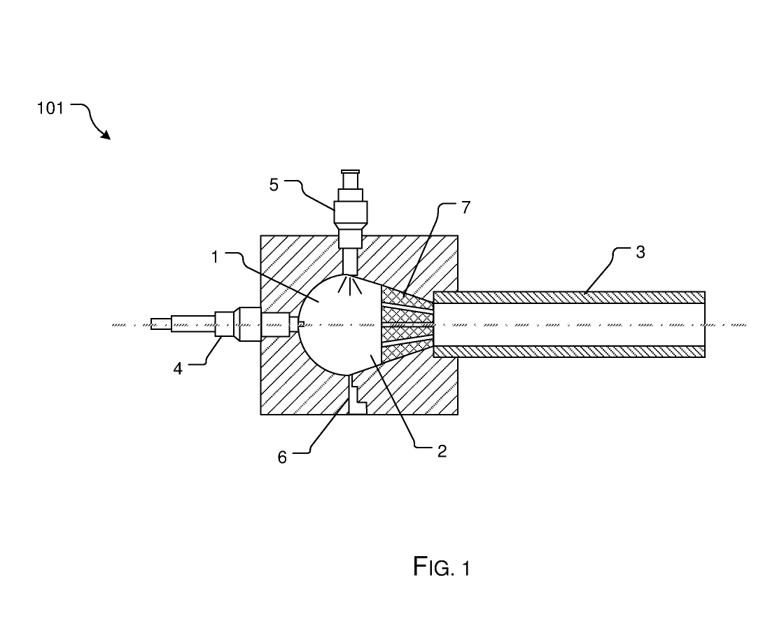

Referring now to the drawings wherein like reference characters identify corresponding or similar elements throughout the several views, FIG. 1 depicts a cross-sectional side view a fuel detonation combustion pulse system and method of use in accordance with a preferred embodiment of the present application. It will be appreciated that system 101 discussed herein overcomes one or more of the above-listed problems commonly associated with conventional systems and methods to arrive at the same results.

It should be understood that the present system 101 relates to propulsion engineering and can be used to create a vehicle thrust and to obtain an engine torque in power plants of various purposes. The task of the proposed engineering solution is to simplify the device design and to enhance its efficiency. It should be understood that the present system 201 achieves these results.

According to the proposed engineering solution, the combustion chamber is provided with a conic duct for transition to the detonation tube. A spark plug for combustion initiation is mounted at the end wall of the hemisphere of the combustion chamber along its longitudinal axis. The system for fuel supply to the combustion chamber is formed as co-axial fuel injector and annular nozzle for oxidant (air, oxygen) supply. The fuel injector and the annular nozzle are positioned perpendicular to the longitudinal axis of the device. The detonation accelerator of the device is located inside the combustion chamber in the conic duct for transition to the detonation tube being co-axial with it and is shaped as a profiled stepped obstacle repeating the profile of the combustion chamber conic duct for transition to the detonation tube.

In the preferred embodiment, the system 101 includes a pulse detonation gas turbine engine 1, comprising of a bundle of four tubes connected via a common converging nozzle at the outlet and operating on a hydrogen-air mixture.

A drawback of this design is large sizes (length of each tube is typically 1165 mm), caused by a pre-detonation distance for a transition of fuel-air mixture combustion to detonation, despite the presence of a 300 mm long spiral inside each tube.

A model demonstrating a liquid fuel pulse detonation engine 2 is known. It represents a device having a two-pipe design with continuous fuel and air supply. The first pipe contains a 28 mm diameter tube and its length is one meter. One end wall of the tube is provided with a nozzle for fuel injection and an electric discharger for fuel-air mixture ignition. The other end wall of the tube is connected via a cone clutch with a 41 mm diameter tube that is submerged into a straight tube of a second 52 mm diameter pipe. To facilitate detonation, the first discharger is followed by length of 40 mm long and 4 mm diameter spiral, behind which an additional element is placed in the form of a 365 mm long tube coil, and then by a second electric discharger. The first contour for periodic detonation initiation in the fuel-air mixture and for formed detonation wave overflow into the second pipe. Air is supplied to the second pipe via a compressor and liquid fuel via a low-pressure automobile nozzle. The open end wall of the second pipe is equipped with a nozzle. Synchronizing the start of the second discharger at the arrival of a detonation wave is being made using a special probe. Having passed the tubes of the first and second pipe the detonation wave enters the atmosphere via the nozzle imparting a jet thrust pulse to the prototype-demonstrator.

The structural complexity and too large sizes of this device (total length of the prototype-demonstrator is 1800 mm) decrease its specific jet thrust characteristics and make it inapplicable for use in vehicles and in other power plants.

A detonation combustion pulse engine [3] (detonation fuel combustion pulse device), comprising a body and wherein a combustion chamber shaped as a semispherical cavity with a nozzle, a detonation initiating mechanism (detonation accelerator), a fuel-air blend supply system and a spark to ignite a mixture is known. The detonation initiating mechanism is shaped as a tube plugged at one end wall. Its free outlet is connected with the center of the semispherical cavity. The fuel-air mixture supply system incorporates an air pipe, a semispherical cavitator, and a reactor where fuel is subjected to partial pyrolysis. The fuel-air mixture if it enters the combustion chamber is ignited by a spark plug (it's location in the prototype is not shown, see the drawing) and detonation is then initiated in the chamber. The engineering solution is in essence most close to the claimed invention (prototype).

The task of the proposed engineering solution is to simplify the design of the device and to enhance its efficiency. The task is solved in the following way. The known fuel detonation combustion pulse device comprises a semispherical combustion chamber, a for fuel supply system, a spark plug, and a detonation accelerator. According to the proposed engineering solution, the semispherical combustion chamber has a conic duct for transition to the detonation tube. The end wall of the semi sphere of the combustion chamber along its longitudinal axis is provided with a spark plug for fueling. The fuel blend supply system is shaped as co-axial fuel injector anti-annular nozzle for oxidant (air, oxygen) supply. The injector and the annular nozzle are positioned perpendicular to the longitudinal axis of the device. The detonation accelerator is placed inside the combustion chamber in the conic duct for transition of the combustion chamber to the detonation chamber being co-axial to it and is made in the form a profiled stepped obstacle repeating the profile of the combustion chamber conic duct to the detonation tube.

In addition, the injector and the annular nozzle can be shifted relative to each other and mounted at an angle to the longitudinal axis of the device. Such embodiment of the injector and the annular increases the interaction area between the fuel flame and the oxidant flow, which favors a better mixing of fuel blend components and, hence, enhances the detonation process.

Thus, a specific embodiment of the combustion chamber, the fuel blend supply system and the detonation accelerator much simplifies the design of the device and enhances its efficiency because it is possible organize a required number of metered pulses with an assigned frequency and to control thrust values over a wide range.

The FIGURE shows the general view of the fuel detonation combustion pulse device. The device consists of the combustion chamber shaped as semi sphere with conic duct 2 for transition to detonation tube 3. The end wall of the semi sphere 1 of the combustion chamber along its longitudinal axis is equipped with spark plug 4 (for example, car's spark plug) for fuel blend ignition. The fuel blend system comprises injector 5 for fuel injection and annular nozzle 6 for oxidant supply to the combustion chamber. Injector 5 and annular nozzle 6 are located in the contact zone of spherical and conic surfaces of the combustion chamber perpendicular to the device axis. Detonation accelerator 7, representing a profiled stepped obstacle is placed inside the combustion chamber and repeats the profile of the conic duct 2 for transition to detonation tube 3.

The operation of the proposed device is cyclic in character and is performed as follows. Oxidant (air, oxygen) enters under pressure via annular nozzle 6 the combustion chamber shaped as semi sphere 1 with conic duct 2 for transition to the detonation tube. At a time, injector 5 injects a certain amount of liquid (gas) fuel while mixing with oxidant and forms a fuel blend of stoichiometric composition. At the moment of complete filling of the combustion chamber and detonation tube 3 a fuel mixture is ignited by spark plug 4. When passing through detonation accelerator 7 the forming flame front is divided into numerous longitudinal and transverse waves that undergo polyfurcation and fire reflected many times from the walls and surfaces of the elements of accelerator 7. Such interaction generates strong shock waves that when occur from detonation accelerator 7 into detonation tube 3 convert to detonation waves. After detonation products have passed to the atmosphere, there occurs a fresh filling of the device with fuel blend components and the cycle repeats.

An assigned fuel mixture composition is achieved by varying the amounts of oxidant and fuel supplied to the combustion chamber, whose flow rate is regulated by pressure and time of an electric signal acting upon the injector. The jet thrust of the proposed device can be regulated over a wide range of the fuel blend (fuel and oxidant) composition, the frequency of fuel injection via the injector and the rime of each injection.

The efficiency of the proposed engineering solution is supported by the experiment made in the model of the pulse device comprising the combustion chamber shaped as a 42 mm diameter semi sphere with a 38 mm long conic duct for transit ion to the detonation tube 20 mm in diameter and 250 mm in length. Heptane was used as fuel oxygen and air—as oxidant. The detonation velocity was measured by the basic method with the use of pressure sensors. The thrust of the pulse device model was measured by a thrust sensor of the Kistler firm. It is found that when a heptane-oxygen-air blend has burnt, detonation generates on the first measuring base, whose length is 147 mm. There the wave is speeded to 2200-2500 m/s, which points to the efficiency of the device in the detonation combustion regime. At that, the thrust value was varied from 16 to 70 N depending on the blend composition and fuel excess coefficient.

Thus, the proposed engineering solution realizes a rapid combustion-to-detonation transition, as well as enables one to use a required number of metered pulse with assigned frequency and to regulate thrust values over a wide range, which guarantees the high efficiency of the device.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. The fuel detonation combustion pulse device comprising:
a semispherical combustion chamber;
a fuel supply system;
a spark plug;
a detonation accelerator;
a hemispherical combustion chamber having a conic duct for transition to the detonation tube;
a spark plug is mounted at the end wall of the sphere of the combustion chamber along its longitudinal axis;
a fuel supply system is formed as a co-axial injector for fuel;
an annular oxidant supply nozzle located perpendicular to the longitudinal axis of the device; and
a detonation accelerator is shaped as a profiled stepped obstacle and is mounted in the combustion chamber conic duct for transition to the detonation tube being axial with it.

2. The device according to claim 1, wherein a nozzle and an annular nozzle are shifted relative to each other and are set at an angle to the longitudinal axis of the device.
